(19) United States
(12) Patent Application Publication
(10) Pub. No.: US 2014/0193677 A1
(43) Pub. Date: Jul. 10, 2014

(54) CONDITIONING OF CABIN AIR OF AN AIRCRAFT

(71) Applicant: Stefan Stückl, Munchen (DE)

(72) Inventor: Stefan Stückl, Munchen (DE)

(73) Assignee: EADS DEUTSCHLAND GMBH, Ottobrunn (DE)

(21) Appl. No.: 14/125,512

(22) PCT Filed: Aug. 6, 2012
(86) PCT No.: PCT/DE2012/100233

§ 371 Date: Mar. 4, 2014

(30) Foreign Application Priority Data
Aug. 12, 2011 (DE) 10 2011 110 068.0

(51) Int. Cl. H01M 10/625; H01M 10/63

(52) U.S. Cl. CPC H01M 10/5016; H01M 10/502
USPC 429/62

(57) ABSTRACT

The invention relates to a devise for conditioning of cabin air from a cabin space of an aircraft that has at least one lithium air battery (106), having a first feed line (101) by means of which ambient air can be delivered to the battery (106) from the environment outside the aircraft, a second feed line (102) by means of which the cabin air from the cabin space can be delivered to the battery (106), a first discharge line (103) by means of which the air from the battery (106) can be delivered into the environment outside the aircraft, a second discharge line (104) by means of which air from the battery (106) can be delivered into the cabin space, a switchable means (105) that is connected to the first (101) and the second (102) feed lines and to the first (103) and second (104) discharge lines and that can adopt a first and second switching state, and a control device (108) by means of which the switchable means (105) can be controlled depending upon a current charging state of the lithium air battery (106).

The invention relates to a device for conditioning of cabin air from a cabin space of an aircraft that has at least one air-breathing lithium air battery, by means of which at least one electrical load of the aircraft that can be connected to the lithium air battery can be supplied with electrical power. The invention further relates to an aircraft having such a device.

Cabin ventilation and cabin pressurization in today's commercial aircraft, owing to the high cruising altitudes, require an expensive pressure and temperature regulation system, by means of which, at the typical cruising altitudes (7.5 to 12 km), pleasant ambient conditions can be established within the pressurized cabin of the passenger aircraft under the ambient conditions encountered at the typical cruising flight altitudes (7.5 to 12 km) (temperature of the ambient air approximately −30° C. to −60° C., ambient pressure 540 to 188 hPa). Here, the cabin air is heated typically to a temperature of approximately 22° C. and compressed to a pressure of at least 750 hPa. In order to continue to have a sufficient quantity of oxygen available at all times within the cabin of an airplane, the entire air mass of the cabin is replaced approximately six times per hour with appropriately compressed ambient air in today's commercial aircraft.

It is known that today the heating and compression of the ambient air in flight is provided largely by a bleed air system which removes the required air-mass flow (so-called bleed air) at an appropriate temperature and at an appropriate pressure from the compressor of the jet engine (gas turbines). The hot, compressed bleed air is mixed with cold ambient air depending on the desired cabin pressure and temperature, and led into the cabin. The leakage rates of the pressurized cabins are here usually negligibly small, so that the pressurized cabin itself can be assumed to be quasi fluid-tight. Today, the consumed cabin air is discharged through outflow valves into the environment of the airplane. As a result, a continuous bleed air mass flow is required, whose compression requires mechanical power, which increases the fuel consumption and which also has a negative effect on the thermodynamic circulation of the jet engines.

In today's passenger planes, ambient air is thus led at predetermined temperature at a predetermined pressure into the pressurized cabin and discharged again subsequently into the environment through the outflow valve. The pressure and temperature regulation system accordingly is an open system, by means of which the air in the environment of the airplane, after having been appropriately conditioned, is led into the airplane cabin and subsequently discharged again from there into the environment of the airplane.

In future passenger planes, particularly in passenger planes that are driven exclusively by electrical motors, it is not sensible to use the above-described pressure and temperature regulation systems for reasons pertaining to energy and efficiency. Such future aircraft conceivably have pressurized cabins that are pressure- and gas-tight, and are therefore able to preserve (maintain) the ground air pressure (the air pressure existing on the ground at the time when the passenger cabin is closed) during the flight. This means that the passenger cabin, at least starting at a predeterminable cruising altitude, forms a closed system, in which the cabin air of the cabin is not continually replaced as in today's passenger planes, but preserved as an air mass in the cabin. However, there is the problem of conditioning and recycling the cabin air during the flight, in particular the problem of regulating the carbon dioxide content or the continuous separation of carbon dioxide from the cabin air.

From DE 30 29 080 A1, a method is known for providing breathing gas for occupants of pressurized cabins in aircraft by increasing the oxygen content in the air in adsorbers. The method is characterized in that an emergency supply of oxygen-rich breathing gas, which is required for possible process interruptions, is generated from air by means of the same adsorbers.

From DE 10 2010 051 964 A1, a secondary lithium oxygen battery system is known, which has a high power output and reversibility. Such a battery system has a layered structure consisting of a lithium anode, a cathode, a separator arranged between the anode and the cathode, which is permeable to lithium ions, an electrolyte wetting the separator and the cathode, a contact area by means of which the electrolyte interacts with oxygen, as well as electrodes, wherein the battery system moreover comprises a reservoir which is filled with the electrolyte and arranged outside of the layered structure of the battery system. Alternatively or additionally, the battery system comprises a pump by means of which the electrolyte can be pumped from the reservoir to the cathode. The lithium oxygen battery system is preferably operated with air and it is particularly suitable for motor vehicles.

From DE 195 22 804 A1, an oxygen feed system feeding into closed spaces (particularly the interior of a motor vehicle) via the air conditioning system is known. Starting from a pressurized container, and previously reduced by means of a pressure reducing valve, oxygen is supplied via the air conditioning system to the interior through a feed line (made of an appropriate material). The oxygen supply can be implemented in two versions. In a first version, a sensor (air quality sensor) measures the oxygen content in the space and regulates the supply automatically. In a second version, the supply is set to automatic or manual feed by a user as desired.

DE 43 35 152 C1 discloses a cabin ambient air system for the air conditioning of hull units of a passenger plane, which regulates the fresh air-mass flow, including pressure and temperature monitoring via a pressurized hull, and which implements a cabin air recycling, with a fresh-air conditioning unit and an air mixing unit, and an air conditioning area arranged downstream of said air mixing unit, which are series connected to one another with respect to the air flow, in which, between the inlet of the fresh-air conditioning unit and an air quantity control valve unit arranged before said fresh-air conditioning unit, a connection with respect to the air flow exists, wherein fresh air, which is preferably bleed air obtained from at least one jet engine, is applied at the inlet of the air quantity control valve unit, wherein a trim air control valve unit is incorporated in the connection with respect to the air flow between the air mixing unit and the air conditioning area, at the inlet of which a portion of the fresh air, which is supplied to the air quantity control valve unit, is applied, in which all the units and/or devices included in an air flow which are connected to one another, and/or units and/or devices connected to the air conditioning area, are connected by means of air flow connection lines, wherein the air conditioning area has a certain amount of leakage, which discharges a portion of the waste air consumed in it to the exterior of the hull unit, in which all the conducting connections between the functionally linked units and/or devices and/or the air conditioning area, which are preferably designed to be electrically conducting, are associated with information exchange. The cabin ambient air system described therein is characterized in that a filter unit for particles, odors and germs, a ventilation unit, and a heat exchanger unit are included in the air flow and the units are series connected with respect to the air flow, the air conditioning area is series connected with respect to the air flow on the outlet side to the inlet of the filter unit, wherein an additional portion of the waste air consumed in the air conditioning area is supplied to the latter filter unit as recirculation air, the heat exchanger unit, which is fed with outside air located outside of the passenger aircraft, is connected with respect to the air flow on the outlet side to another inlet of the air mixing unit, wherein conditioned recirculation air is supplied to the latter air mixing unit; a cabin pressure regulation device, an air conditioning system regulation device, and a cabin zone regulation device are series connected in a conducting and functional manner, wherein a mutual information exchange between these elements occurs; the air quantity control valve unit is connected in a conducting and functional manner to the cabin pressure regulation unit and the fresh-air conditioning unit is connected in a conducting and functional manner to the air conditioning system regulation device, and the heat exchanger unit is connected in a conducting and functional manner to the cabin zone regulation device, wherein a mutual information exchange occurs between these elements,—in each case one inlet of the cabin zone regulation device is connected in a conducting manner to the air mixing device and to a functional interface, which is associated with the air flow connection between the air mixing device and the air conditioning area, as well as to the air conditioning area, wherein the elements which are functionally connected on the input side to the cabin zone regulation device provide unilaterally directed information to said cabin zone regulation device, in each case one outlet of the cabin zone regulation device is connected in a conducting manner to the trim air control valve unit and to the aerator unit, wherein the elements connected functionally on the output side to the cabin zone regulation device (3) receive unilaterally directed information from the latter.

The invention is based on the problem of providing a device by means of which the cabin air of an aircraft, in particular of an aircraft having a pressure- and gas-tight pressurized cabin (closed system), can be conditioned in a reliable and simple manner.

The invention is achieved by the features of the independent claims. Advantageous variants and designs are the subject matter of the dependent claims. Further features, application possibilities and advantages of the invention result from the following description as well as from the explanation of embodiment examples of the invention which are represented in the figures.

The problem is solved with a device for conditioning of cabin air from a cabin space of an aircraft, wherein the aircraft comprises at least one lithium air battery by means of which at least one electrical load of the aircraft, which can be connected to the lithium air battery, can be supplied with electrical power.

Such a load is, in particular, an electrical motor for driving the aircraft in the air or on the ground. Naturally, the term “electrical load” can also include, in the present case, any other loads of the aircraft, such as, for example, avionic systems, lighting systems, an on-board network, entertainment systems, etc.

The term air-breathing “lithium air battery” denotes, as is known, a battery in which the cathode is replaced by oxygen, so that for the energy removal of the battery, oxygen (or ambient air) has to be supplied, and therefore the attribute “air-breathing” is used. As anode of the battery, metal lithium is used, which can participate completely in the reaction. Since the oxygen required for the reaction can be removed from the ambient air, the capacity of a lithium air cell is determined by the size of the lithium anode alone. The theoretically achievable energy density, if one does not takes into consideration the weight of the oxygen, is approximately 11,000 Wh/kg in the case of a nominal voltage of 2.96 V. During the discharging process, on the anode side of the battery, a lithium atom separates from an electron which flows via the load to the cathode side. In the battery, the lithium ion migrates through an electrolyte to the cathode side. From the ambient air, oxygen atoms diffuse into the porous cathode material, where the lithium ion is oxidized and again takes up an electron. In this process, lithium peroxide Li₂O₂ is formed according to the formula:

2 Li+O₂→Li₂O₂ 1)

As is known, lithium peroxide can be used for conditioning breathing air, by separating carbon dioxide from consumed breathing air consumed breathing air according to the following equation and with the formation of lithium carbonate oxygen:

2 Li₂O₂+2 CO₂→2 Li₂CO₃+O₂. 2)

The lithium air battery is designed or encapsulated so as to be air- or pressure-tight.

According to the invention, the device comprises a first feed line by means of which the lithium air battery can be supplied with ambient air from an environment outside the aircraft, a second feed line by means of which the lithium air battery can be supplied with the cabin air from the cabin space, a first discharge line by means of which the air from the lithium air battery can be discharged into the environment outside of the aircraft, and a second discharge line by means of which air from the lithium air battery can be supplied to the cabin space.

The feed and discharge lines are all designed to be gas- and pressure-tight.

Moreover, the device according to the invention comprises a switchable means which is connected to the first and the second feed lines as well as to the first and the second discharge lines, and which has the following two switching states. The switchable means can comprise, for example, a valve connected to each feed line or each discharge line, valve which allows through flow or blocks the respective feed line/discharge line in an air- and pressure-tight manner. Naturally, the person skilled in the art is familiar with additional suitable embodiments of the switchable means in the prior art.

In a first switching state of the means, the lithium air battery can be supplied exclusively through the first feed line with ambient air from outside the aircraft, which, after flowing through the lithium air battery, can be returned exclusively through the first discharge line to the environment. In the first switching state, the supplying of cabin air to the lithium air battery through the second feed line and the removal of air from the lithium air battery through the second discharge line are prevented. Thus, in this first switching state, no cabin air escapes through the second feed line or the second discharge line and the battery into the environment of the aircraft, and no supply of ambient air into the cabin occurs. If the cabin space itself is pressure-tight, then the cabin space forms a closed space in the first switching state as well, which maintains in particular its cabin pressure, and thus also does not allow any gas exchange with the environment of the aircraft.

In the first switching state, only the oxygen-containing ambient air required for energy removal is supplied to the lithium air battery. The at least one load can form a closed current circuit with the lithium air battery, i.e., remove electrical energy, only in this first switching state.

A preferred variant of the device according to the invention is characterized in that a compressor is connected in the first feed line, by means of which a pressure at which the ambient air can be supplied to the lithium air battery can be set, in particular kept constant, and/or in that a temperature regulation device is connected in the first feed line, by means of which device a temperature at which the ambient air can be supplied to the lithium air battery can be regulated, in particular kept constant. This has the advantage that the process occurring in the case of energy removal from the lithium air battery (see equation 2) can occur under (predeterminable) conditions that are optimal with regard to pressure and temperature for this process.

Moreover, it is preferable for the lithium air battery to be designed in such a manner that the ambient air and the cabin air can flow through only one porous cathode of the lithium air battery. In this manner, the volume of the lithium air battery through which flow can take place is reduced and limited to the portion essential to the reaction. Both features lead to an increase of the reaction effectiveness and thus of the efficiency of the energy conversion.

In a second switching state of the means according to the invention, the lithium air battery can be supplied with the cabin air only through the second feed line, air which, after flowing through the lithium air battery, can be returned exclusively through the second discharge line, as conditioned cabin air, to the cabin space, wherein, in the second switching state, a supplying of the ambient air to the lithium air battery through the first feed line and a discharge of air from the lithium air battery through the first discharge line are prevented. Therefore, in this second switching state as well, there is no escape of cabin air through the second feed line or the second discharge line and the battery into the environment of the aircraft, and no supply of ambient air to the cabin. If the cabin space itself is pressure-tight, then the cabin space, together with the second feed line, the lithium air battery, and the second discharge line, forms a closed system in the second switching state as well, by maintaining the cabin pressure, and there is also no gas exchange with the environment of the aircraft.

In the second switching state, the lithium air battery is used exclusively for conditioning of the cabin air, by separating carbon dioxide from the cabin air while the air flows through the lithium air battery (preferably its porous cathode), and the oxygen content of the cabin is increased according to the above indicated equation 2). An energy removal from the battery through the at least one load does not occur in the second switching state, i.e., a closed current circuit with the load and the battery cannot be produced in the second switching state.

Finally, the device according to the invention comprises a control device, by means of which the switchable means can be controlled depending on the current charging state of the lithium air battery. The control device preferably comprises a processor unit, a storage unit, a programming means, as well as an input means, by means of which the programming means can be changed.

The invention is particularly suitable for conditioning of cabin air of future aircraft which use electrical motors together with lithium air batteries as driving means, and which comprise a pressurized cabin which is designed to be pressure- and gas-tight. In this case, the continuous compressor work of a conventional pressurization system or an electrically operated pressurization system can be dispensed with, which considerably increases the energy efficiency of such aircraft. Moreover, the moisture content in the cabin air can be increased, because this air is not aerated with the extremely dry outside air at high cruising altitude; instead a closed system exists, from which the cabin air does not escape but is only conditioned as needed. A higher moisture content of the cabin air noticeably increases the passenger comfort. In order to further condition the cabin air, the device preferably comprises filters (for example, filters containing activated charcoal) or filter systems for air cleaning, in particular for removing odors from the cabin air.

A preferred variant of the device according to the invention is characterized in that the control device is designed and set up in such a manner that, if the current charging state of the lithium air battery is above a predetermined value, the means is switched to/is in the first switching state, and it is only when the current charging state falls below this predetermined value that the means can be switched to the second switching state.

As a result, in the first switching state, the lithium air battery is available only for supplying power to the at least one load. As explained above, the lithium air battery (the cathode) is supplied for this purpose via the first feed line with ambient air, resulting in an increase in lithium peroxide as the ambient air flows through the battery. After flowing through the lithium air battery, the air is returned through the first discharge line back to the environment of the aircraft. The mass throughput of ambient air required for the energy removal depends on the battery size and also on the energy removal, and it must be selected accordingly. It is only when a sufficient quantity of lithium peroxide is formed by the energy removal in the lithium air battery that the lithium air battery can be used in principle for conditioning of the cabin air according to equation 2).

The increase in the lithium peroxide quantity in the lithium air battery goes hand in hand with a corresponding decrease of the energy stored in the lithium air battery, i.e., a decrease of the charging state of the battery. The charging state (charging state value) is indicated in the present case as a percentage of the maximum charging state. If the battery is completely charged, the charging state value is 100%, and if it is completely discharged, the charging state value is 0%. The lower the charging state value is, the higher the lithium peroxide concentration in the lithium air battery is.

The switching of the means to the second switching state occurs in this variant as soon as the predetermined value of the charging state of the lithium air battery fails to be reached. The value has to be selected so it is appropriate for each use. The predetermined value is preferably 0 to 90% of the maximum charging state value, and, in particular, the value is preferably 80%, 70%, 60%, 50%, 40%, 30%, 20%, 10%, or 5% of the maximum charging state value. For the conditioning of the cabin air, small charging state values are naturally advantageous, because in that case the largest quantity of lithium dioxide is present in the battery, so that the conditioning effectiveness is highest.

In a preferred variant, the control device should be designed and set up in such a manner that, as soon as the current charging state falls below the predetermined value, the means automatically switches to the second switching state. If the predetermined value is selected appropriately, one can ensure that the switching from the first switching state to the second switching state always occurs in the optimal charging state value.

The switching into the second switching state can also occur as a function of an aircraft state. The term “state of the aircraft” is here understood to have a broad meaning covering, for example, the following states: the aircraft is still on the ground, the aircraft is taxiing, the aircraft is accelerating, the aircraft is flying, states of the configuration of the aircraft, such as landing gear deployed/retracted, flaps set, etc. In this variant, it is possible, for example, to define two or more conditions for switching from the first switching state of the means to the second switching state of the means. Thus, for example, an automatic switching from the first switching state to the second switching state can occur automatically if the following conditions are met:
the charging state value is less than 60%,
the aircraft is flying, and
the cruising altitude exceeds 3000 feet.

In this manner, a first of several lithium air batteries of an electrical passenger plane can be used for all ground activities, including the starting process and the first steep ascent, in order to supply the electrical motor for driving the aircraft and optionally additional systems with electrical energy, before the electrical supply at the time of or before the occurrence of the above conditions is taken over by one of the additional batteries, and the first battery is used for conditioning the cabin air.

The conditioning of the cabin air requires, as described, a sufficient quantity of lithium peroxide in the battery, which is consumed by the conditioning of the cabin air. It is preferable to provide therefore that the lithium air battery is used only for conditioning the cabin air until sufficient lithium peroxide is present in the battery. If this is no longer the case, it is preferable to use an additional lithium air battery for conditioning the air that is present on board, to the extent that it satisfies the above condition(s).

A situation where a predetermined lithium peroxide concentration in the lithium air battery is no longer reached, which prevents the continued use of this battery for conditioning the air, can occur, as indicated by monitoring the difference between the carbon dioxide and/or oxygen concentration in the second feed line and the carbon dioxide and/or oxygen concentration in the second discharge line. Appropriate measurement means are known to the person skilled in the art.

In a further embodiment, the control device is designed and set up in such a manner that, as soon as the current charging state falls below the predetermined value, the means can be switched first by a manual actuation of an input means to the second switching state. In this variant, it is possible, for example, for the aircraft personnel, particularly the pilot, to make a final decision as to the time when the switch of the use of a lithium air battery as energy source or for conditioning the air occurs. A so-called override function is also possible, by means of which an automatic switching can be reversed or occur at an earlier time. In this manner, the crew of the aircraft has direct intervention possibilities, so that the corresponding use of the lithium air batteries can be adapted in a targeted manner to an existing situation. Typically several lithium air batteries are present in the aircraft, wherein it is preferable to provide the possibility of an automatic usage control of all the batteries as well as the possibility of the targeted control of each individual battery.

An additional particularly preferred variant of the device according to the invention is characterized in that a compressor is connected in the first feed line, by means of which a pressure at which the ambient air can be supplied to the lithium air battery can be set, in particular kept constant and/or in that a temperature regulation device is connected in the first feed line, by means of which a temperature at which the ambient air can be supplied to the lithium air battery can be regulated, in particular kept constant. Owing to the possibility of regulating the temperature and/or the pressure at which the ambient air is supplied to the lithium air battery, the reaction conditions for the reaction can be set optimally according to equation 2) and thus the reaction effectiveness can be increased.

An additional aspect of the invention relates to an aircraft, in particular an aircraft having a drive system which uses at least one electrical motor that has a device as described above. It is preferable for the aircraft to comprise a pressure- and gas-tight pressurized cabin.

Additional advantages, characteristics and details result from the following description in which, in reference to the drawings, an embodiment example is described in detail. Features described and/or depicted in the representation in themselves or in any reasonable combination constitute the subject matter of the invention, possibly also independently of the claims, and they can in particular also be additionally the subject matter of one or more separate applications. Identical, similar and/or functionally equivalent parts are provided with the same reference numerals.

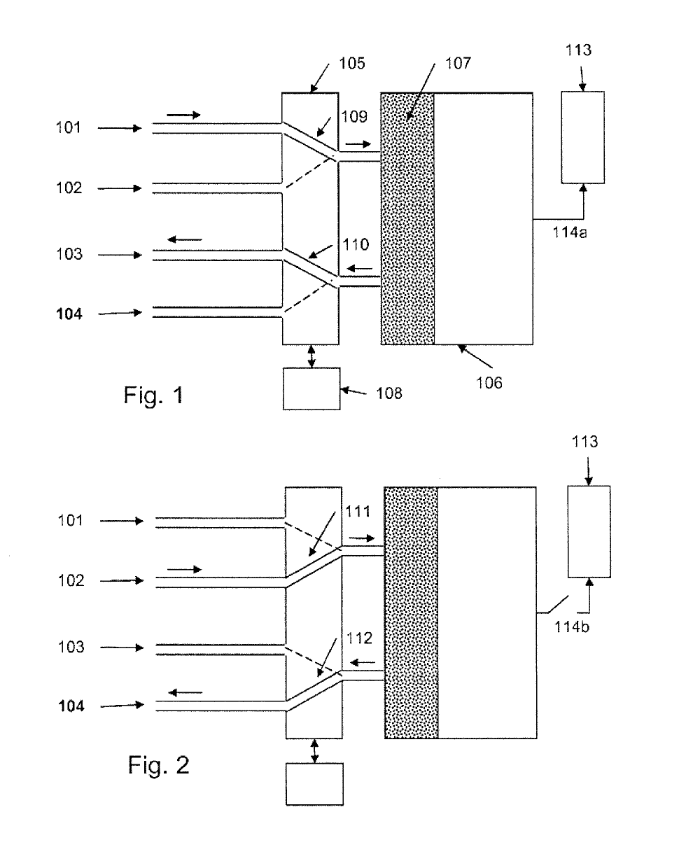

FIG. 1 shows a diagrammatic representation of the device according to the invention in a first switching state, and

FIG. 2 shows a diagrammatic representation of the device according to the invention in a second switching state.

The described embodiment example of FIG. 1 and FIG. 2 is based on an aircraft that is driven exclusively by electrical motor and that comprises a completely gas- and pressure-tight pressurized cabin in the closed state.

FIG. 1 shows a diagrammatic representation of the device according to the invention for conditioning of cabin air from a cabin space (not shown) of the aircraft (not shown), which comprises several lithium air batteries of which only one 106 is represented. Using the battery 106, in FIG. 1, an electrical motor (load) can be supplied, which drives a propeller (not shown) for propelling the aircraft. The present invention comprises: a first feed line 101 by means of which ambient air from an environment outside of the airplane can be supplied to the lithium air battery 106 (the flow directions are indicated with arrows in the figures), a second feed line 102 by means of which the cabin air from the cabin space (not shown) can be supplied to the lithium air battery 106, a first discharge line 103 by means of which air from the lithium air battery 106 can be discharged into the environment outside of the aircraft, and a second discharge line 104 by means of which the from the lithium air battery 106 can be supplied to the cabin space. Moreover, the represented device comprises a switchable means 105 connected to the first 101 and to the second 102 feed line and to the first 103 and to the second 104 discharge line, by means of which, in the represented first switching state of the means 105, the ambient air from outside of the airplane can be supplied exclusively through the first feed line 101 to the lithium air battery 106, ambient air which, after it has flowed through a porous cathode 107 of the lithium air battery 106 can be returned exclusively through the first discharge line 103 to the environment. In the represented first switching state, the supplying of cabin air to the lithium air battery 106 through the second feed line 102 and the discharge of air from the lithium air battery 106 through the second discharge line 104 are prevented, which is indicated by the broken lines. The means 105 is connected to a control device 108, by means of which the switchable means 105 can be controlled depending on a current charging state of the lithium air battery 106. In the represented first switching state of the means 105, the lithium air battery can be used exclusively for the energy supply of the load 113. The electrical connection 114a between battery 106 and load 113 is therefore closed. In the switchable means 105, the first feed line is moreover connected via the connection 109 to the battery 106. Moreover, the battery 106 is connected via the connection 110 to the first discharge line 103, so that the ambient air which flows into the battery 106 also flows again out of the battery.

FIG. 2 is based on FIG. 1 and it shows a second switching state of the means 105 in which the cabin air can be supplied exclusively through the second feed line 102 to the lithium air battery 106, and, after it has flowed through the lithium air battery 106, it can be returned exclusively through the second feed line 104 as conditioned cabin air to the cabin space. In the represented second switching state, the supplying of the ambient air to the lithium air battery 106 through the first feed line 101 and the discharge of air from the lithium air battery 106 through the first discharge line 103 are prevented, which is indicated by the broken lines. Moreover, in the switchable means 105, the second feed line 102 is connected via the connection 111 to the battery 106. Moreover, the battery 106 is connected via the connection 112 to the second discharge line 104, so that the cabin air which flows into the battery 106 can also flow out of the battery again. The represented second switching state of the means allows a conditioning of the cabin air as it flows through the lithium air battery 106, by carbon dioxide separation from the cabin air and the supply of oxygen, in particular by a reaction of the cabin air with the lithium peroxide Li₂O₂ present in the lithium air battery 106. In the second switching state, the electrical load 113 can be supplied with electrical energy, which is indicated by the open electrical connection 114b.

The device according to the invention can be controlled in such a manner, for example, that the following operating scenario of the aircraft is implemented:

1. The aircraft taxis on the ground by its own force (thrust by the propeller driven by the electrical motor 113) to the runway and takes off. The outside air at low cruising altitude is still used for the direct aeration of the cabins without compression of the outside air. During the taxiing and the takeoff process, a portion of the battery is discharged and enriched with lithium peroxide.

2. The aircraft reaches a cruising altitude at which pressurization of the cabin becomes necessary. For this purpose, the batteries which were used for the takeoff and the early ascent are sealed off from the outside air, and connected by the switchable means to the cabin. The switching from the first switching state to the second switching state for these batteries occurs in such a manner that no pressure pulse can be felt in the cabin. The cabin is now connected as a closed system to the batteries which already have, as a result of sufficient discharging, a sufficient quantity of lithium peroxide and are thus used for conditioning the cabin air. By recycling the cabin air, the consumed cabin air is led from the cabin space through the porous cathodes of the battery, cleaned of CO₂, and returned enriched with O₂ to the cabin space.

3. During the further course of the flight, in each case additional discharged batteries are separated by the switchable means 105 by from the outside air and incorporated in the air conditioning system.

4. Once a suitably low altitude has been reached (for example, 2500 m NN) during the descent, the pressurized cabin is supplied with outside air, while, for example, all the batteries are switched by the switchable means 104 into a first switching state, and are thus available for energy use or for a go-around maneuver.

In order to generate the required quantity of lithium peroxide on board the aircraft, appropriately large batteries are required. Therefore, the described device is particularly suitable for electrically driven aircraft whose energy is stored primarily or partially in an air-breathing lithium battery.

### LIST OF REFERENCE NUMERALS

101 First feed line
102 Second feed line
103 First discharge line
104 Second discharge line
105 Switchable means
106 Lithium air battery
107 Porous cathode
108 Control device
109 Connection of the first feed line to the battery according to the first switching state
110 Connection of the first discharge line to the battery according to the first switching state
111 Connection of the second feed line to the battery according to the second switching state
112 Connection of the second discharge line to the battery according to the second switching state
113 Electrical load, electrical motor for driving a propeller
114a Electrical connection between lithium air battery and load closed
114b Electrical connection between lithium air battery and load open

1. A device for operating a lithium air battery of an aircraft, by means of which at least one electrical load of the aircraft, which can be connected to the lithium air battery, can be supplied with electrical energy, and for conditioning of cabin air from a cabin space of the aircraft, with
a first feed line, by means of which ambient air from an environment outside of the aircraft can be supplied to the lithium air battery,
a second feed line, by means of which cabin air from the cabin space can be supplied tot he lithium air battery,
a first discharge line, by means of which air from the lithium air battery can be supplied to the environment outside of the aircraft,
a second discharge line, by means of which the air from the lithium air battery can be supplied to the cabin space,
a switchable means connected to the first and to the second feed line as well as to the first and to the second discharge line, by means of which, in a first switching state of the means, the ambient air can be supplied from outside the aircraft to the lithium air battery exclusively through the first line, and, after it has flowed through the lithium air battery, it can be returned exclusively through the first discharge line to the environment, wherein, in the first switching state, the supplying of cabin air to the lithium air battery through the second feed line and the discharge of air from the lithium air battery through the second discharge line are prevented, and by means of which, in a second switching state of the means, the cabin air can be supplied to the lithium air battery exclusively through the second feed line, and, after it has flowed through the lithium air battery, it can be returned excluisvely through the second discharge line, as conditioned cabin air, to the cabin space, wherein, in the second switching sate, the supplying of the ambient air to the lithium air battery through the first feed line and the discharge of air from the lithium air battery through the first discharge line are prevented, and
and a control device by means of which the switchable means can be controlled depending on a current charging state of the lithium air battery,
wherein:
the electrical load can be supplied with electrical energy by the lithium air battery only in the first switching state, and
the conditioning of the cabin air in the second switching state as it flows through the lithium air battery occurs by carbon dioxide separation from the cabin air and by the supply of oxygen, in particular by a reaction of the cabin air with the lithium peroxide Li₂O₂ present in the lithium air battery.

2. The device according to claim 1, wherein the control device is designed and set up in such a manner that, if the current charging state of the lithium air battery is above a predetermined value, the means is switched into the first switching state, and it is only after the current charging state falls below this predetermined value that the means can be switched into the seconds switching state.

3. The device according to claim 2, wherein the predetermined value is between 0 and 90% of the maximum charging state value, in particular: 80%, 70%, 60%, 50%, 40%, 30%, 20%, 10%, or 5% of the maximum charging state value.

4. The device according to claim 2, wherein the control device is designed and set up in such a manner that, as soon as the current charging state falls below the predetermined value, the means switches automatically into the second switching state.

5. The device according to claim 4, wherein switching into the second switching state occurs only if a predeterminable state of the aircraft exists.

6. The device according to claim 2, wherein the control device is designed and set up in such a manner that as soon as the current charging state falls below this predetermined value, the means can first be switched by a manual actuation of an input means into the second switching state.

7. The device according to claim 1, wherein the at least one load is an electrical motor for propelling the aircraft.

8. The device according to claim 1, wherein a compressor is connected in the first feed line, by means of which compressor a pressure at which the ambient air of the lithium air battery can be supplied can be set, in particular kept constant, and/or in that a temperature regulation device is connected in the first feed line, by means of which a temperature at which the ambient air of the lithium air battery can be supplied can be regulated, in particular kept constant.

9. The device according to claim 1, wherein the lithium air battery comprises a porous cathode and the lithium air battery is designed in such a manner that the ambient air and the cabin air can flow only through the porous cathode.
